(19) United States
(12) Patent Application Publication
(10) Pub. No.: US 2005/0228663 A1
(43) Pub. Date: Oct. 13, 2005

(54) Media production system using time alignment to scripts

(76) Inventors: Robert Boman, Thousand Oaks, CA (US); Patrick Nguyen, Santa Barbara, CA (US); Jean-Claude Junqua, Santa Barbara, CA (US)

Correspondence Address: HARNESS, DICKEY & PIERCE, P.L.C., P.O. BOX 828, BLOOMFIELD HILLS, MI, 48303, US

(21) Appl. No.: 10/814,960

(22) Filed: Mar. 31, 2004

(51) Int. Cl. G10L 15/26

(52) U.S. Cl. 704/235

(57) ABSTRACT

A media production system includes a textual alignment module aligning multiple speech recordings to textual lines of a script based on speech recognition results. A navigation module responds to user navigation selections respective of the textual lines of the script by communicating to the user corresponding, line-specific portions of the multiple speech recordings. An editing module responds to user associations of multiple speech recordings with textual lines by accumulating line-specific portions of the multiple speech recordings in a combination recording based on at least one of relationships of textual lines in the script to the combination recording, and temporal alignments between the multiple speech recordings and the combination recording.

### FIELD OF THE INVENTION

The present invention generally relates to media production systems, and particularly relates to media production using time alignment to scripts.

### BACKGROUND OF THE INVENTION

Today's media production procedures typically require careful assembly of takes of recorded speech into a final media product. For example, big budget motion pictures are typically first silently filmed in multiple takes, which are cut and joined together during an editing process. Then, the audio accompaniment is added to multiple sound tracks, including music, sound effects, and speech of the actors. Thus, actors are often required to dub their own lines. Dubbing processes also occur when a finished film, television program, or the like is dubbed into another language. In each of these cases, multiple takes are usually recorded for each actor respective of each of the actor's lines. Speech recordings are sometimes made for each actor separately, but multiple actors can also participate together in a dubbing session. In either of these cases, a director/editor may coach the actor between takes or even during takes through headphones from a recording studio control room. Dozens of takes may result for each line, with even more takes for especially difficult lines that require additional attempts.

The synchronization between a spoken line and a visual line is typically achieved by the actor's skill. However, unless the director/editor is happy with an entire take for a scene, then the director/editor is faced with the difficult and time consuming task of sorting through all of the takes for that scene, finding a usable take for each line, and combining the selected portions of each take together in the proper sequence. The difficulty of this task is somewhat eased where a temporal alignment is maintained between each speech take and the video recording. In this case, the director/editor can navigate through a scene visually and sample takes for each line. Once points are indicated for switching from one take to another, the mixing down process is relatively simple. However, unless the director/editor has designated in notes at recording time which takes are of interest to which lines and in what way, the task of finding suitable takes can be confusing and time consuming.

Also, radio spots and audio/video recordings using on-location sound often need to be edited together from multiple takes. In the cases of television spots using on-location sound and radio spots, there is often a duration requirement to which the finished media products must conform. Typically, spots of varying durations need to be developed form the same script, such as a fifteen second spot, a thirty second spot, a forty-five second spot, and one minute spot. In such cases, the one-minute spot can include all of the lines of a script, while the shorter duration spots can each contain a subset of these lines. Thus, four scripts containing common lines may be worked out in advance, but the one-minute script may be recorded for each of the multiple takes. In these cases, the director/editor may need usable takes for each line of varying durations to ensure that the different spots can be produced accordingly. However, the director/editor has little choice but to laboriously search through the takes to find the lines of usable quality and duration.

Further, automated systems employing recorded speech, such as video games and voicemail systems, have lines of a script mapped to discrete states of the system. In this case, a director/editor may require voice talent to read all of their lines in a particular sequence for each take, or may require the lines to each be read as separate takes. However, the director/editor is once again faced with the task of sorting through the multiple takes to find the proper takes and/or portions of takes for a particular state, and to select from among plural takes for each line.

Finally, speech recordings developed from scripted training speech for automatic speech recognizers and speech synthesizers also typically include multiple takes. A director selecting training data for discrete speech units is even further challenged by the task of sorting through the multiple takes to find one take for each line that is most suitable for use as training speech. This task is similarly confusing and time consuming.

The need remains for a media production technique that reduces the labor and confusion of navigating multiple takes of recorded speech. For example, there is a need for a navigation modality that does not require the user to move back and forth through speech recordings by trial and error, either blindly or with reference to another recording. The need also remains for a navigation modality that automatically assists the user in identifying which takes are most likely to contain a suitable speech recording for a particular line. The present invention fulfills these needs.

### SUMMARY OF THE INVENTION

In accordance with the present invention, a media production system includes a textual alignment module aligning multiple speech recordings to textual lines of a script based on speech recognition results. A navigation module responds to user navigation selections respective of the textual lines of the script by communicating to the user corresponding, line-specific portions of the multiple speech recordings. An editing module responds to user associations of multiple speech recordings with textual lines, by accumulating line-specific portions of the multiple speech recordings in a combination recording based on at least one of relationships of textual lines in the script to the combination recording, and temporal alignments between the multiple speech recordings and the combination recording.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a block diagram illustrating a media production system according to the present invention;

FIG. 2 is a block diagram illustrating alignment and ranking modules according to the present invention;

FIG. 3 is a block diagram illustrating navigation and editing modules according to the present invention;

FIG. 4 is a view of a graphic user interface according to the present invention; and

FIG. 5 is a flow diagram illustrating the method of the present invention.

### DETAILED DESCRIPTION OF THE PREFERRED EMBODIMENTS

The following description of the preferred embodiments is merely exemplary in nature and is in no way intended to limit the invention, its application, or uses.

The present invention provides a media production system that uses textual alignment of lines of a script to contents of multiple speech recordings based on speech recognition results. Accordingly, the user is permitted to navigate the contents of the multiple speech recordings by reference to the textual lines of the script. Association of takes with textual lines is therefore greatly facilitated by reducing confusion and increasing efficiency. The details of navigation and the types of combination recordings produced vary greatly depending on the type of media being produced and the stage of production.

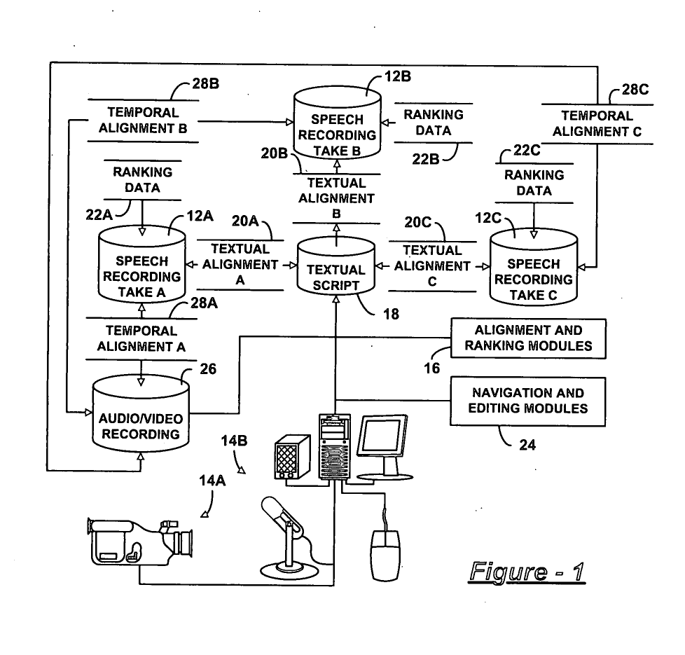

FIG. 1 illustrates a media production system according to the present invention. Some details are included that are specific to use of the system in a dubbing process. However, as more fully explained below, the same system components used in a dubbing process may be employed in various audio and video media production processes, including production of radio commercials, production of speech recognizer/synthesizer training data, and production of sets of voice prompts or notices for use in answering machines, video games, and other consumer products having navigable states with related speech media.

Following production of multiple speech recordings 12A-12C, via recording devices, such as video camera 14A and/or digital studio 14B, alignment and ranking modules 16 align the multiple speech recordings 12A-12C to textual script 18. Accordingly, each speech recording 12A-12C has a particular textual alignment 20A-20C to textual script 18. Also, alignment and ranking modules 16 evaluate the speech recordings 12A-12C in various ways and tag locations of the speech recordings 12A-12C with ranking data 22A-22C indicating suitability of related speech segments for use with textual lines of script 18.

Ranking data 22A-22C is used by navigation and editing modules 24 to rank takes with respect to textual lines during a subsequent editing process that accumulates line-specific portions of the multiple speech recordings in a combination recording 26 according to associations of multiple speech recordings 12A-12C with textual lines of script 18. In other words, the user specifies a speech recording for each line of the script either manually, as facilitated by the ranking, or by confirming an automatic selection according to the ranking. Thus, each line has a particular take selected for it, and the line-specific takes from multiple speech recordings 12A-12C are accumulated into the combination recording 26 based on relationships of textual lines in the script 18 to the combination recording 26, and/or temporal alignments 28A-28B between the multiple speech recordings 12A-12C and the combination recording 26.

As mentioned above, accumulation of the line-specific segments into a combination recording 26 may be based on temporal alignments 28A-28B between the multiple speech recordings 12A-12C and the combination recording 26, For example, in a dubbing process, each speech recording 12A-12C is temporally aligned with a combination recording 26 that is a preexisting audio/video recording. These temporal alignments 28A-28B are formed as each speech recording 12A-12C is created. Accordingly, each speech recording 12A-12C has a particular temporal alignment 28A-28C to combination recording 26. Thus, textual alignments 20A-20C in combination with temporal alignments 28A-28C serve to align textual lines of script 18 to combination recording 26. As a result, speech segments selected for lines in the script 18 are taken from the multiple speech recordings 12A-12C and deposited in portions of speech tracks of the audio/video recording to which they are temporally aligned.

As also mentioned above, accumulation of the line-specific segments into a combination recording 26 may be based on relationships of textual lines in the script 18 to the combination recording 26. For example, multiple takes of audio and/or audio/video recordings produced from a sequentially-ordered script can be accumulated into a combination recording such as a radio or television commercial based on the sequential order of the lines in the script. Stringent durational constraints may be automatically enforced in these cases, and sub-scripts may be created with different durational constraints. In the case of a full-length feature film, multiple takes of an audio/video recording results in multiple video recordings temporally aligned to multiple speech recordings, which are in turn aligned to a sequentially ordered script. Thus, a user may employ the present invention to edit multiple audio/video takes into a combination audio/video recording based on sequential order of the lines in the script. It is envisioned that the video portion of the recording thus produced may subsequently be dubbed according to the present invention.

Non-sequential relationships of textual lines in the script 18 to the combination recording 26 may also be employed to assemble the combination recording. For example, if the combination recording is a navigable, multi-state system, such as a video game, answering machine, voicemail system, or call-routing switchboard, then the textual lines of the script are associated with memory locations, metadata tags, and/or equivalent identifiers referenced by state-dependent code retrieving speech media. Thus, the selected, line-specific speech recording segments are stored in appropriate memory locations, tagged with appropriate metadata, or otherwise accumulated into a combination recording of speech media capable of being referenced by the navigable, multi-state system. Similar functionality obtains with respect to assembling a data store of speech training data, with the script serving to maintain an alignment between speech data and a collection of speech snippets forming a set of training data.

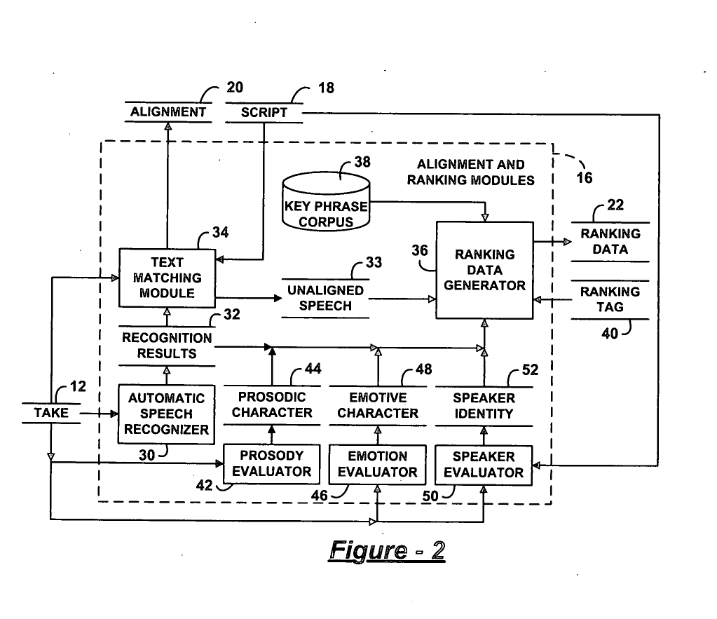

Turning to FIG. 2, alignment and ranking modules 16 process speech recording 12 respective of script 18 to form textual alignment 20 and ranking data 22. Accordingly, automatic speech recognizer 30 produces recognition results 32 in textual form, which text matching module 34 uses to produce alignment 20 by aligning speech recording 12 with script 18. Thus, pointers are created between textual lines of script 18 and matching portions of speech recording 12. Ranking data generator 36 also uses speech recognition results 32 to produce ranking data 22 indicating quality of speech. For example, a confidence score associated with a word may be interpreted to indicate clarity of the speech recognized as that word. Accordingly, a tag reflecting this confidence score may be added to the speech recording, with a bidirectional pointer between the score and one or more speech file memory locations storing the speech data recognized as the word. Also, existence of unaligned speech 33 not aligned with text of script 18 may be interpreted as a misspoken line, misrecognized speech, or an interruption of a take by another speaker. Accordingly, a tag may be added to the portion of the speech recording containing the unaligned text indicating presence of unaligned speech.

Ranking data generator 36 may recognize key phrases of corpus 38 within the speech recording 12 or associated with the speech recording 12 at time of creation as a voice tag 40. Thus, a director during filming or during a dubbing process may speak at the end of a take to express an opinion of whether the take was good or not. Similarly, the director during a dubbing process may, from a sound proof booth, speak a voice tag to be recorded in another track of the recording to express an opinion about a particular portion of a take. Other voice tagging methods may also be used to tag an entire take or portion of a take. Accordingly, ranking data generator can recognize key phrases and tag the entire take or portion of the take as appropriate. It is also envisioned that a take can be tagged during filming, dubbing, or other take producing process with a silent remote control that allows the director to silently vote about a portion of a take without having to speak. These ranking tags 40 can also be interpreted by ranking data generator 36, or may serve directly as ranking data 22.

Ranking data generator 36 can generate other types of ranking data 22. For example, prosody evaluator 42 can evaluate prosodic character 44 of speech recording 12, such as pitch and/or speed of speech. Accordingly, ranking data generator 36 can tag corresponding locations of speech recording 12 with appropriate ranking data 22. Also, emotion evaluator 46 can evaluate emotive character 48 of speech recording 12, such as intensity of speech. Accordingly, ranking data generator 36 can tag corresponding locations of speech recording 12 with appropriate ranking data 22. Further, speaker evaluator 50 can determine a speaker identity 52 of a speaker producing a particular portion of speech recording 12. Accordingly, ranking data generator 36 can tag corresponding locations of speech recording 12 with appropriate ranking data 22.

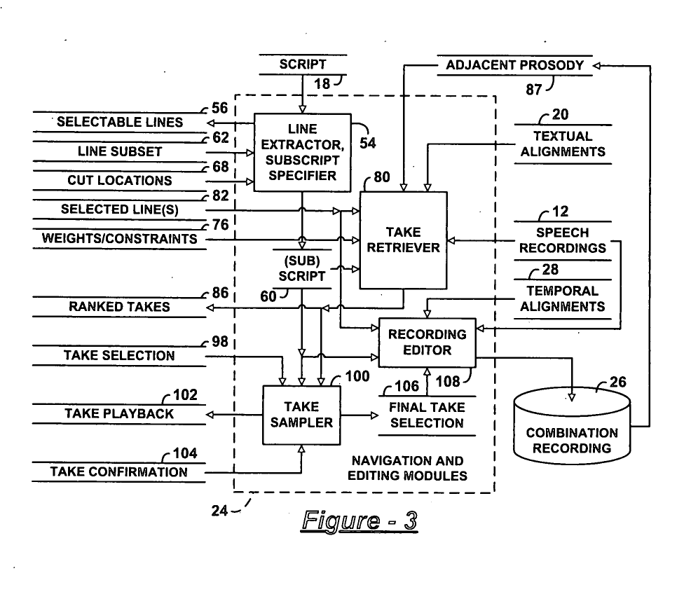

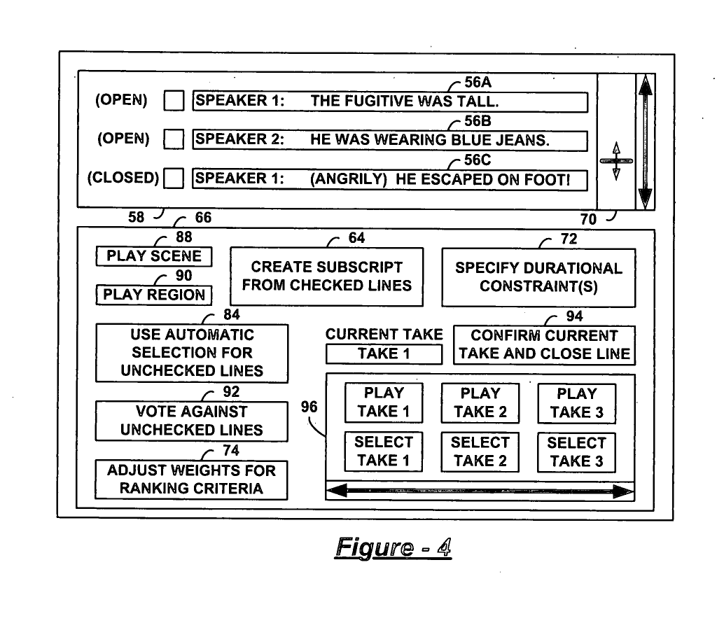

FIG. 3 illustrates navigation and editing modules 24 in greater detail. A user interface implementing the components of modules 24 is illustrated in FIG. 4. For example, line extractor and subscript specifier 54 extracts lines of script 18 and communicates them to the user as selectable lines 56 in line selection window 58. If desired, the user can create a subscript 60 from a line subset 62 by checking off lines of the subset in window 58 and clicking command button 64 in take selection window 66. Also, if the user is editing audio/video takes, then the user may wish to define where cuts occur. Accordingly, the user can instantiate cut locations on cut bar 70 to impose a constraint that lines positioned between cut locations must be from the same take. Deletion of lines due to formation of a subscript may automatically add a cut location wherever lines have been deleted. Also, the user may be allowed to reorder lines in the script by clicking and dragging them in window 58, which may also cause cut locations to be created automatically. Cut locations may also be written into the script, either as an original stage direction or as a handwritten markup. Accordingly, stage directions and markups indicating cut locations may be extracted and recognized to create cut locations automatically.

The user may also be permitted to impose additional constraints on a script or subscript, such as an overall duration, by accessing a constraint definition toll via command button 74. The user can further specify a weighting of ranking criteria, and may store and retrieve customized weightings for different production processes by accessing and using a weighting definition tool via command button 76. These weights and constraints 78 are communicated to take retriever 80, which retrieves ranked takes 86 for selected lines 82 according to the weights and constraints 78.

The user is permitted to use automatic selection for any unchecked lines via command button 84. Alternatively, the user can click on a particular line in window 58 to select it. Take retriever 80 then obtains portions of speech recordings 12 for the script/subscript 60 according to textual alignments 20 and cut locations 68. If a durational constraint is imposed, then take retriever 80 computes various combinatorial solutions of the obtained portions and considers a take's ability to contribute to the solutions when ranking the takes. Also, take retriever 80 ranks the obtained portions using global and local ranking data respective of the weighted ranking criteria. For example, the emotive character of a portion of a speech recording aligned to a textual line may be considered, especially if the line has an emotive state associated with it in the script. Speaker identity can also be considered based on the speaker of the line in the script. Further, a first ranked take may be considered tentatively selected for each line, and rankings may be adjusted to find takes that are consistent with takes that are adjacent to them. Thus, adjacent prosody 87, such as pitch and speed, may be considered as part of the ranking criteria.

The user may sample and select takes using take selection window 66. Accordingly, the user may select all of the first ranked takes in an entire scene for play back via command button. Alternatively, the user can select a line within a continuous region between cuts and select to play back the continuous region with the first ranked take via command button 90. If cuts are used, all of the lines between the cuts are treated as one line, and must be selected together. If the user does not like a particular take for a particular line, then the user can check the lines that have acceptable takes and use automatic selection for the unchecked lines via command button 84. The user may wish to vote against the unchecked lines to reduce the rankings of their current takes, either temporarily or permanently, via command button 92. This reduction in rank helps to ensure that new takes are retrieved for the unchecked lines. Alternatively, the automatic selection may constrain retrieval to obtain different takes. If a durational constraint is employed, then the combinatorial solutions of takes for the unchecked lines are computed with consideration given to the summed duration of the checked lines and/or any closed lines. A closed line results when the user selects a line and confirms the current take for that line via command button 94.

Finally, the user can select an individual line and view ranked takes for that line in take selection sub-window 96. Takes may be ranked in part according to the reverse order in which they were created on the assumption that better results were achieved in subsequent takes. Accordingly, the user can make a take sample selection 98 by clicking on a take, which causes take sampler 100 to perform a take playback 102 of the portion of that take aligned to the currently selected line. The user can also select a take as the current take for that line and make a take confirmation 104 of the current take via command button 94. The final take selections 106 are communicated to recording editor 108, which uses either temporal alignments 28 or script/subscript 60 relationships to the combination recording 26 to accumulate the selected portions of speech recordings 12 in combination recording 26.

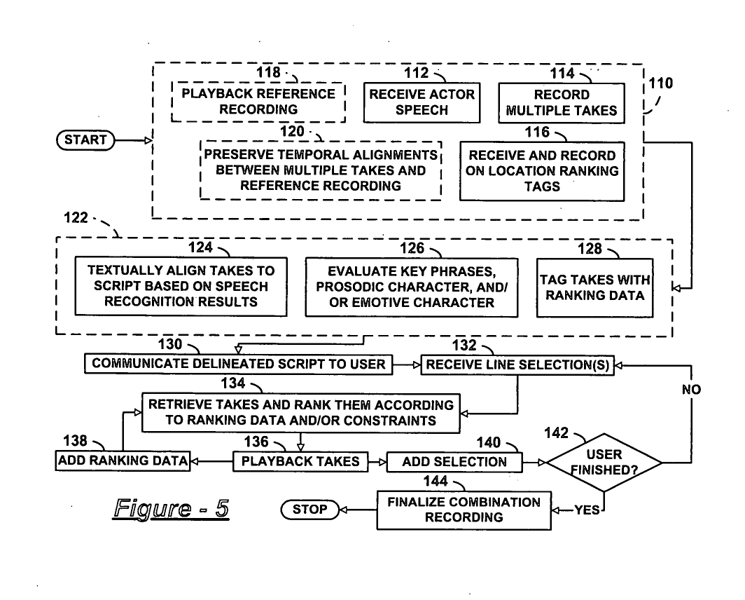

The method of the present invention is illustrated in FIG. 5, and includes creating multiple speech recordings at step 110. Step 110 includes receiving actor speech at sub-step 112, recording multiple takes at sub-step 114, and receiving and recording on location ranking tags at sub-step 116. If the takes are produced during a dubbing process, then step 110 includes playing back a reference video recording at sub-step 118, and preserving temporal alignments between the multiple takes and the reference recording at sub-step 120. The method also includes a processing step 122, which includes textually aligning the takes to the script based on speech recognition results at sub-step 124. Step 122 also includes evaluating key phrases, prosodic and/or emotive character, and/or speaker identity at sub-step 126. Step 122 further includes tagging takes with ranking data at sub-step 128 based on speech recognition results, key phrases, prosodic and/or emotive character, and/or speaker identity.

After recording and processing of the recordings at steps 110 and 122, the delineated script is communicated to the user at step 130, and the user is permitted to navigate, sample, and select speech recordings by selecting lines of the script and selecting takes for each line. Accordingly, upon receiving one or more line selections at step 132, portions of speech recordings aligned to the selected lines are retrieved and ranked for the user at step 134. The user can filter the takes as desired by adjusting the weighting criteria for a line or group of lines, and can specify constraints such as overall duration, cut locations, and tentative or final selections for some of the lines. Accordingly, the user can play back takes at step 136 one at a time for a particular line, or can play an entire scene or continuous region. Then, the user can add ranking data for a take at step 138 and/or select a take for the combination recording at step 140. Once the user is finished as at 142, the combination recording is finalized at step 144.

The description of the invention is merely exemplary in nature and, thus, variations that do not depart from the gist of the invention are intended to be within the scope of the invention. Such variations are not to be regarded as a departure from the spirit and scope of the invention.

1. A media production system, comprising:
a textual alignment module aligning multiple speech recordings to textual lines of a script based on speech recognition results;
a navigation module responding to user navigation selections respective of the textual lines of the script by communicating to the user corresponding, line-specific portions of the multiple speech recordings; and
an editing module responding to user associations of multiple speech recordings with textual lines by accumulating line-specific portions of the multiple speech recordings in a combination recording based on at least one of relationships of textual lines in the script to the combination recording, and temporal alignments between the multiple speech recordings and the combination recording.

2. The system of claim 1, further comprising a ranking module adapted to tag at least one of speech recordings and specific portions thereof with ranking data.

3. The system of claim 2, wherein said ranking module is adapted to recognize tags associated with the speech recordings and tag at least one of speech recordings and specific portions thereof accordingly.

4. The system of claim 3, wherein said ranking module is adapted to recognize voice tags based on key phrases.

5. The system of claim 2, wherein said ranking module is adapted to recognize key phrases within the speech recordings and tag at least one of speech recordings and specific portions thereof accordingly.

6. The system of claim 2, wherein said ranking module is adapted to evaluate pitch of speech within the speech recordings and tag at least one of speech recordings and specific portions thereof accordingly.

7. The system of claim 2, wherein said ranking module is adapted to evaluate speed of speech within the speech recordings and tag at least one of speech recordings and specific portions thereof accordingly.

8. The system of claim 2, wherein said ranking module is adapted to evaluate emotive character of speech within the speech recordings and tag at least one of speech recordings and specific portions thereof accordingly.

9. The system of claim 1, wherein said navigation module is adapted to rank at least one of speech recordings and specific portions thereof based on predetermined ranking criteria and at least one of:
(a) characteristics of at least one of speech recordings and specific portions thereof; and
(b) ranking data associated with at least one of speech recordings and specific portions thereof.

10. The system of claim 9, further wherein said navigation module is adapted to rank at least one of speech, recordings and specific portions thereof based on order in which the speech recordings were produced.

11. The system of claim 9, wherein said navigation module is adapted to rank at least one of speech recordings and specific portions thereof based on quality of pronunciation of speech therein.

12. The system of claim 9, wherein said navigation module is adapted to rank at least one of speech recordings and specific portions thereof based on pitch of speech therein.

13. The system of claim 9, wherein said navigation module is adapted to rank at least one of speech recordings and specific portions thereof based on speed of speech therein.

14. The system of claim 9, wherein said navigation module is adapted to rank at least one of speech recordings and specific portions thereof based on duration thereof.

15. The system of claim 9, wherein said navigation module is adapted to rank a line-specific portion of a speech recording based on consistency thereof with at least one adjacent, line-specific portion of another speech recording already assigned to a textual line sequentially adjacent in the script to a textual line aligned to the line-specific portion of the speech recording.

16. The system of claim 9, wherein said navigation module is adapted to rank at least one of speech recordings and specific portions thereof based on ability of thereof to contribute to solutions rendering a combination recording of a target duration and including a partial accumulation of line-specific portions of the multiple speech recordings.

17. The system of claim 9, wherein said navigation module is adapted to rank at least one of speech recordings and specific portions thereof based on ranking tags supplied thereto by speech recording production personnel during a speech recording process.

18. The system of claim 9, wherein said navigation module is adapted to rank at least one of speech recordings and specific portions thereof based on emotive character exhibited thereby and a target emotive state recorded with respect to a textual line aligned thereto.

19. The system of claim 9, wherein said navigation module is adapted to rank at least one of speech recordings and specific portions thereof in accordance with user-specified weights respective of multiple ranking criteria.

20. The system of claim 9, wherein said navigation module is adapted to automatically select at least one of speech recordings and specific portions thereof based on the predetermined ranking criteria.

21. The system of claim 1, wherein said navigation module is adapted to play a user-specified portion of a speech recording in response to a sample request.

22. The system of claim 1, wherein said navigation module is adapted to play at least one of a user-specified section of the combination recording and a preview of the user-specified section based on a sequence of portions of multiple speech recordings.

23. The system of claim 1, wherein said navigation module is adapted to record final selection of at least one of a speech recording and a specific portion thereof with respect to a textual line.

24. The system of claim 1, wherein the combination recording includes at least one voice track of a multiple track audio visual recording, the speech recordings are produced in a dubbing process, and each speech recording is automatically temporally aligned to the combination recording during the dubbing process.

25. The system of claim 1, wherein the textual lines are sequentially related and the combination recording includes at least one audio track having a durational constraint.

26. The system of claim 1, wherein the combination recording includes a navigable set of voice prompts.

27. The system of claim 1, wherein the combination recording includes a set of training data for at least one of a speech synthesizer and a speech recognizer.
